(19) United States
(12) Patent Application Publication
(10) Pub. No.: US 2022/0044217 A1
(43) Pub. Date: Feb. 10, 2022

(54) SYSTEMS AND METHODS FOR DETERMINING TIMING OF A REMITTANCE PAYMENT

(71) Applicant: Wells Fargo Bank, N.A., San Francisco, CA (US)

(72) Inventors: Stephen J. Clark, San Francisco, CA (US); Daniel Ayala, Antioch, CA (US); Deborah Canale, Scottsdale, AZ (US); Laura Havighurst, Van Meter, IA (US); Sridhar Uppaluri, Minneapolis, MN (US); Robert A. Cantrell, Pleasant Hill, CA (US)

(21) Appl. No.: 14/918,159

(22) Filed: Oct. 20, 2015

Related U.S. Application Data
(60) Provisional application No. 62/066,812, filed on Oct. 21, 2014.

(51) Int. Cl. G06Q 20/10; G06Q 20/14; G06Q 10/10

(52) U.S. Cl. CPC G06Q 20/102; G06Q 10/1097; G06Q 20/14

(57) ABSTRACT

A method includes, based on a request from a payor to initiate a remittance payment, determining a start time for processing the remittance payment and calculating an initial processing duration attributable to a remittance provider computer system and associated with the remittance payment. The method also includes determining availability of a partner associated with the remittance provider computer system to process the remittance payment, wherein the availability of the partner is determined according to the start time and the initial processing duration and based on calendar information received from the partner. The method also includes calculating a partner processing duration for the partner to process the remittance payment, and calculating a date of availability for a payee to access the remittance payment, wherein the date of availability is calculated based on the availability of the partner to process the remittance payment and the partner processing duration.

### CROSS-REFERENCE TO RELATED APPLICATIONS

This application claims priority to U.S. Provisional Patent Application No. 62/066,812, entitled “Systems and Methods for Determining Timing of a Remittance Payment,” filed on Oct. 21, 2014, which is incorporated herein by reference in its entirety and for all purposes.

### BACKGROUND

The present disclosure relates generally to the field of remittance transfers. More specifically, the present disclosure relates to systems and methods for estimating the timing of a remittance transfer.

Remittance transfers may be used to send (i.e., transfer) a sum of money (i.e., a remittance) in payment for goods or services, or as a gift. For instance, it is common for a person working in a foreign country to send a remittance to an individual in his or her own country. Various regulations may require a provider of the remittance transfer (e.g., a financial institution providing remittance transfers for a consumer) to disclose to a sender, prior to payment, the date on which funds will be available to the designated recipient of the remittance. The remittance transfer provider typically provides a fixed time frame (i.e., 10 days) by which the remittance will be available, regardless of the details regarding a particular remittance transfer.

The fixed time frame disclosed by the provider may be sufficient to guarantee that any given remittance is available to the recipient, even though a particular remittance may be available sooner than the time frame provided. Thus, funds may be available to the recipient days prior to the sender or the recipient having knowledge that the funds are available.

### SUMMARY

One embodiment of the present disclosure relates to a remittance payment processing system. The remittance payment processing system includes a remittance provider bank computer system, which includes an availability date calculator configured to estimate a date by which a recipient may access a remittance payment. The availability date calculator includes start date logic for determining a start date, processing lag time logic for determining an initial lag time for the remittance payment at the provider bank computer system, aggregator availability logic for determining availability of an aggregator computer system, aggregator processing time logic for determining a processing time of the remittance payment at the aggregator system, remittance network member (RNM) availability logic for determining availability of an RNM system, and RNM processing time logic for determining a processing time of the remittance payment at the RNM system. The remittance provider bank computer system also includes a dynamic transaction disclosure receipt (DTDR) generator for generating a DTDR based on the availability date.

Another embodiment of the present disclosure relates to a computer-implemented method for determining an availability date by which a recipient may access a remittance payment. The method includes determining, by a bank computer system, an initial estimated availability date for a remittance payment based on information received from a payor, determining a processing lag time for processing the remittance payment at the bank computer system, adding the processing lag time to the estimated availability date, determining an availability of an aggregator system according to the estimated availability date, determining a processing time for processing the remittance payment at the aggregator system, adding the aggregator processing time to the estimated availability date, determining an availability of a remittance network member (RNM) system according to the estimated availability date, determining a processing time for processing the remittance payment at the RNM system, and adding the RNM processing time to the estimated availability date.

Another embodiment of the present disclosure relates to a computer-implemented method. The method includes, based on a request from a payor to initiate a remittance payment, determining, by a remittance provider computer system, a start time for processing the remittance payment and calculating an initial processing duration attributable to the remittance provider computer system and associated with the remittance payment. The method also includes determining, by the remittance provider computer system, availability of a partner associated with the remittance provider computer system to process the remittance payment, wherein the availability of the partner is determined according to the start time and the initial processing duration and based on calendar information received from the partner. The method also includes calculating, by the remittance provider computer system, a partner processing duration for the partner to process the remittance payment, calculating, by the remittance provider computer system, a date of availability for a payee to access the remittance payment, wherein the date of availability is calculated based on the availability of the partner to process the remittance payment and the partner processing duration, and providing, by the remittance provider computer system, a disclosure receipt to the payor, the disclosure receipt including one or more terms of the remittance payment, the one or more terms including the date of availability.

Another embodiment of the present disclosure relates to a computer-implemented method. The method includes receiving, at a remittance provider computer system, a request from a payor to initiate a remittance payment, and calculating, by the remittance provider computer system, a date of availability for a payee to access funds related to the remittance payment. Calculating the date of availability includes based on the request, determining a start time for processing the remittance payment, and calculating an initial processing duration attributable to the remittance provider computer system and associated with the remittance payment, wherein the initial processing duration is calculated based on the time between when the date of availability is provided to the payor and when a payment instruction for the remittance payment is sent to an aggregator computer system. Calculating the date of availability also includes determining availability of the aggregator computer system to process the remittance payment, wherein the availability of the aggregator computer system is determined according to the start time and the initial processing duration, and based on calendar information received from the aggregator computer system, and calculating an aggregator processing duration for the aggregator computer system to process the remittance payment, wherein the date of availability is calculated based on the availability of the aggregator computer system and the aggregator processing duration. The method further includes providing, by the remittance provider computer system, a disclosure receipt to the payor prior to processing the remittance payment, the disclosure receipt including one or more terms of the remittance payment, the one or more terms including the date of availability.

Another embodiment of the present disclosure relates to a computer-implemented method. The method includes receiving, at a remittance provider computer system, a request from a payor to initiate a remittance payment, and calculating, by the remittance provider computer system, a date of availability for a payee to access funds associated with the remittance payment. Calculating the date of availability includes, based on the request, determining a start time for processing the remittance payment, calculating an initial processing duration attributable to the remittance provider computer system and associated with the remittance payment, wherein the initial processing duration is calculated based on the time between when the date of availability is provided to the payor and when a payment instruction for the remittance payment is sent to an aggregator computer system, and calculating a modified start time by adding the initial processing duration to the start time.

In this embodiment, calculating the date of availability also includes determining a next available time for the aggregator computer system to process the remittance payment based on the modified start time and calendar information received from the aggregator computer system, calculating an aggregator processing duration for the aggregator computer system to process the remittance payment, generating an aggregator completion time by adding the aggregator processing duration to the next available time of the aggregator computer system, determining a next available time for a remittance network member (RNM) computer system to process the remittance payment based on the aggregator completion time and calendar information received from the RNM computer system, and calculating an RNM processing duration for the RNM computer system to process the remittance payment, wherein the date of availability is calculated by adding the RNM processing duration to the aggregator completion time. The method further includes providing, by the remittance provider computer system, a disclosure receipt to the payor prior to processing the remittance payment, the disclosure receipt including one or more terms of the remittance payment, the one or more terms including the date of availability.

### BRIEF DESCRIPTION OF THE FIGURES

The details of one or more implementations are set forth in the accompanying drawings and the description below. Other features, aspects, and advantages of the disclosure will become apparent from the description, the drawings, and the claims, in which:

FIG. 1 is a schematic diagram of a remittance payment processing system, according to an example embodiment.

FIG. 2 is an example process that may be implemented using the system shown in FIG. 1.

FIG. 3 is a screen display of a user interface showing a start date and a processing lag time for a provider bank computer system, according to an example embodiment.

FIG. 4 is a screen display of a user interface showing a business calendar for an aggregator computer system, according to an example embodiment.

FIG. 5 is a screen display of a user interface showing processing hours for an aggregator computer system, according to an example embodiment.

FIG. 6 is a screen display of a user interface showing lag processing time for an RNM computer system, according to an example embodiment.

FIG. 7 is a screen display of a user interface showing foreign taxes and fees associated with an RNM computer system, according to an example embodiment.

FIG. 8 is a screen display of a user interface showing a business calendar according to a payment type, according to an example embodiment.

FIG. 9 is a screen display of a user interface showing processing hours according to a payment type, according to an example embodiment.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting.

Referring generally to the figures, systems and methods for determining timing of a remittance payment are shown and described. More particularly, the present disclosure relates to determining a date by which a remittance payment will be made available to a recipient. For instance, the disclosed systems and methods may be utilized to determine when associated systems will be available for use in processing the remittance payment, as well as to estimate the processing times required by each of the associated systems to complete the payment.

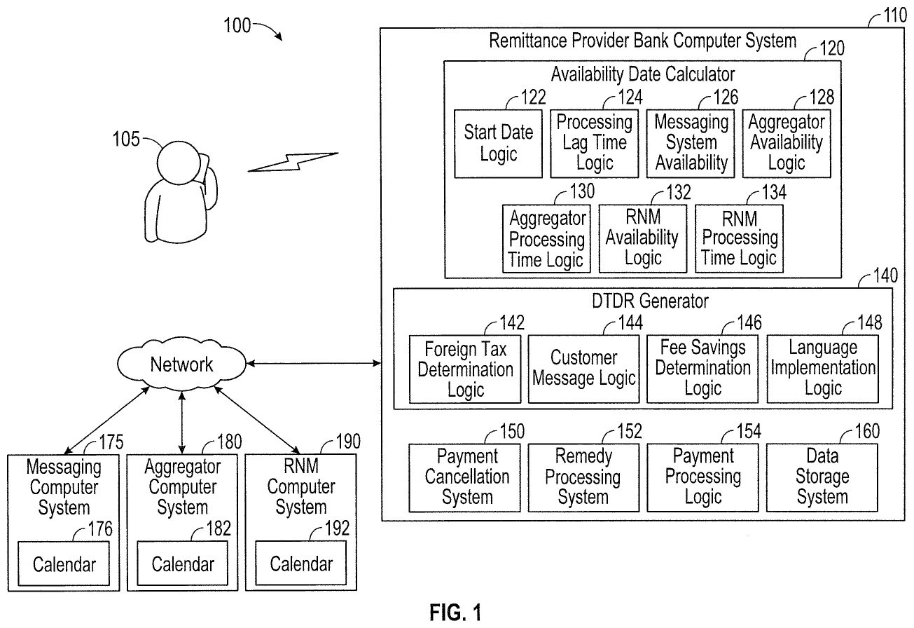

Referring to FIG. 1, a remittance payment processing system 100 is shown, according to an example embodiment. The remittance payment processing system 100 may be used to process a remittance payment (i.e., transaction, transfer) initiated by a payor 105. The remittance payment processing system 100 may also provide various information related to processing of the remittance payment, including providing required disclosure information to the payor 105 prior to processing the payment. The remittance payment processing system 100 may include, among other systems, a provider bank computer system 110, a messaging computer system 175, an aggregator computer system 180, and a remittance network member (RNM) computer system 190.

In an example embodiment, the provider bank computer system 110 may be provided by a financial institution, such as a bank. The provider bank computer system 110 is configured to receive various details from the payor 105 regarding a requested remittance payment and transmit a payment instruction according to the details received from the payor 105. Where the provider bank computer system 110 is provided by a financial institution, the payor 105 may be a customer of the financial institution that accesses the provider bank computer system 110 through tellers at retail bank branches, through an online banking area provided by the financial institution, or otherwise. In other embodiments, the payor 105 may be any other sender able to interface with provider bank computer system 110 to request transfer of a remittance payment. In an exemplary embodiment, the provider bank computer system 110 provides information to the payor 105 regarding the remittance payment, such as a total cost for the transaction and a date by which the payment funds will become available, prior to transmitting the payment instruction.

Upon approval or other confirmation by the payor 105, the provider bank computer system 110 may transmit the payment instruction to the aggregator computer system 180 in order to process the payment. The provider bank computer system 110 may send the payment instruction directly to the aggregator computer system 180 or the payment instruction may be sent via the messaging computer system 175. For instance, the payment instruction may not be readable or in the proper format to be processed by the aggregator computer system 180. In such embodiments, the messaging computer system 175 may receive the payment instruction from the provider bank computer system 110 and send the payment instruction to the aggregator computer system 180 for processing. The messaging computer system 175 may be configured to interpret and/or modify the payment instruction so that the aggregator computer system 180 may understand and process the message. The aggregator computer system 180 is configured to receive the payment instruction and provide the instruction to the RNM computer system 190 in a format that can be interpreted and processed by the RNM computer system 190. The RNM computer system 190 is configured to receive the payment instruction and process the payment such that the remittance funds are available to the recipient.

The provider bank computer system 110 includes an availability date calculator 120 configured to calculate an estimated availability date by which the remittance funds will be available to the recipient. The provider bank computer system 110 may provide a guarantee that the remittance payment will be available to the recipient by the availability date. For instance, the availability date may refer to a date by which the remittance payment will be processed and received by a remittance network member (e.g., RNM computer system 190), such that the funds are available to the recipient. The availability date may refer to a specific time by which the funds will be available to the payee (e.g., Oct. 21, 2014 at 10:00 AM), or the availability date may simply refer to a calendar date by which the funds will be made available. The availability date calculator 120 calculates the availability date based on information related to the remittance payment, such as information received from the payor 105 upon requesting the remittance payment, as well as information retrieved from any of messaging computer system 175, aggregator computer system 180, RNM computer system 190, and data storage system 160.

In the example embodiment of FIG. 1, the availability date calculator 120 includes start date logic 122, processing lag time logic 124, messaging system availability logic 126, aggregator availability logic 128, aggregator processing time logic 130, RNM availability logic 132, and RNM processing time logic 134. Such logic may be implemented in a machine (e.g., one or more networked computer servers) comprising machine-readable media having instructions stored therein which are executed by the machine to perform the operations described herein. For instance, such logic may be implemented and executed to derive values that may be used to calculate an estimated availability date for receipt of the remittance payment.

The start date logic 122 may be executed to determine an initial date or time for determining an estimated availability date for the remittance payment. The start date may be used as a basis, or starting point, for calculating the estimated availability time. In other words, the start date may indicate when a timer for the remittance payment process is started. In an example embodiment, the start date refers to the time at which the payor 105 is given the option to execute (i.e., confirm) the remittance payment. For instance, the provider bank computer system 110 may provide the payor 105 with various details regarding a requested remittance payment, including an estimated availability date by which the payment will be available to the recipient. The start date may refer to the time at which these details are disclosed to the payor 105. In other embodiments, the start date may refer to the time at which the availability date is calculated, or the time at which the remittance payment is requested by the payor 105. In one embodiment, the start date refers to the time at which requisite remittance payment information (i.e., information required to initiate a remittance payment) is provided by the payor 105.

The start date may be determined based on information stored in the data storage system 160. For instance, the start date logic 122 may access a calendar or other timekeeper stored within the data storage system 160 and use the stored information to determine a start date. In other embodiments, the start date may be determined based on information received from elsewhere within the system 100. The start date may be determined according to the time zone of the payor 105, or according to the time zone of the recipient. The start date may also be modified in some embodiments, such as to provide an availability date based on a remittance transaction to be initiated at a future date.

The processing lag time logic 124 may determine (e.g., calculate, estimate, etc.) a processing lag time between when the availability date is calculated and when the provider bank computer system 110 actually transmits the payment instruction. For instance, the provider bank computer system 110 may provide the availability date to the payor 105 upon receiving a request to process a remittance payment. The provider bank computer system 110 may then require the payor 105 to confirm (i.e., accept) the availability date prior to transmitting a payment instruction to a partner or agent of the bank computer system 110 (e.g., aggregator computer system 180) or otherwise proceeding with the remittance payment. The processing lag time logic 124 includes, as part of the processing lag time, the time between when the availability date is provided to the payor 105 and when the availability date is confirmed by the payor 105 (i.e., the confirmation period). In an example embodiment, the confirmation period is a predetermined period of time. For instance, the provider bank computer system 110 may provide a set period of time for the payor 105 to confirm the remittance payment details. The processing lag time logic 124 may include the full predetermined confirmation period as part of the processing lag time. The confirmation period may be a maximum time allotted for the payor 105 to confirm the remittance payment before the availability date expires, requiring the payor 105 to re-submit the transaction request. The full confirmation period may be built into the estimated processing lag time regardless of how quickly the payor 105 confirms the payment, or the processing lag time may be updated and included as part of the availability date immediately upon confirmation by the payor 105. In one embodiment, the confirmation period is approximately sixty (60) minutes.

The processing lag time logic 124 may also determine a cancellation period for the remittance payment and include the duration of the cancellation period as part of the processing lag time. For instance, the provider bank computer system 110 may hold the payment instruction for a period of time (i.e., the cancellation period) upon receiving confirmation of the remittance payment from the payor 105. During this cancellation period, the provider bank computer system 110 does not transmit the payment instruction, instead allowing the payor 105 to cancel the remittance request at any time during this cancellation period for a full refund (including taxes and fees). The processing lag time logic 124 includes the cancellation period as part of the processing lag time because no processing occurs until after the cancellation period has passed.

The processing lag time logic 124 may also estimate other internal processing time of the provider bank computer system 110 and include as part of the processing lag time. For instance, any processing time for polling or during an end of day freeze period may be accounted for and included as part of the processing lag time. The processing lag time logic 124 is configured to, when executed, sum the confirmation period, the cancellation period, and any other processing delays associated with the provider bank computer system 110 to determine a total processing lag time. The total processing lag time may be added to the start date by the availability date calculator 120 in order to account for the processing time inherent at the provider bank computer system 110.

In some embodiments, the messaging computer system 175 facilitates delivery of the payment instruction from the provider bank computer system 110 to the aggregator computer system 180. The messaging system availability logic 126 may determine whether the messaging computer system 175 is available to receive or otherwise process the payment instruction from the provider bank computer system 110. The messaging system availability logic 126, when executed, may retrieve availability information from the data storage system 160 or receive the information directly from the messaging computer system 175 (e.g., upon request). For instance, the messaging system availability logic 126 may access a calendar for the messaging computer system 175 (e.g., calendar 176) in order to determine whether the messaging computer system 175 is available to process a message such as the payment instruction received from the provider bank computer system 110. As an example, the calendar 176 may indicate the dates and times that the messaging computer system 175 is operational and therefore able to receive the payment instruction from the provider bank computer system 110. If the messaging system availability logic 126 determines that the messaging computer system 175 is unavailable at the relevant time, the messaging system availability logic 126 determines the next available date and time that the messaging computer system 175 is available and may provide this information as an output. In an example embodiment, the messaging system availability logic 126 determines whether the messaging computer system 175 is scheduled to be available upon completion of the processing lag time at the provider bank computer system 110.

Likewise, the aggregator availability logic 128 may determine whether the aggregator computer system 180 is available to receive or otherwise process the payment instruction from the provider bank computer system 110. The payment instruction may be received at the aggregator computer system 180 directly from the provider bank computer system 110 or via the messaging computer system 175. When executed, the aggregator availability logic 128 may access a calendar (e.g., calendar 182) for the aggregator computer system 180 in order to determine whether the aggregator computer system 180 is available to receive the payment instruction at the relevant time.

The relevant time for determining availability of the aggregator computer system 180 may be determined by the availability date calculator 120. In an example embodiment, the relevant time is based on the start time and the processing lag time that were previously calculated. For instance, the aggregator availability logic 128 may determine if the aggregator computer system 180 is available after the start time and upon completion of the processing lag time at the provider bank computer system 110. The relevant time may also be based on the availability of the messaging computer system 175. For instance, if the messaging computer system 175 is used to facilitate sending the payment instruction from the provider bank computer system 110 to the aggregator computer system 180, the relevant time may be after a time during which the messaging computer system 175 was available to facilitate delivery of the payment instruction to the aggregator computer system 180.

The aggregator processing time logic 130 may determine (e.g., estimate, calculate) the processing time required at the aggregator computer system 180. The aggregator processing time may include any time after receipt of the payment instruction at the aggregator computer system 180 before the payment instruction can be available in a form necessary for processing by the RNM computer system 190. For instance, the aggregator computer system 180 may interpret the payment instruction received from the provider bank computer system 110 and send a message to the RNM computer system 190 that is indicative of the payment instruction. The aggregator processing time determined by the aggregator processing time logic 130 is an estimate or calculation that is based on information stored within the data storage system 160 or provided by the aggregator computer system 180. In an example embodiment, the aggregator processing time is intended to be a “worst case” processing time in order to ensure that the funds are available to the recipient of the remittance payment on the availability date. The aggregator processing time logic 130 may provide the determined aggregator processing time as an output. The availability date calculator 120 may add the aggregator processing time to the first time at which the aggregator computer system 180 becomes available.

The RNM availability logic 132 may, when executed, determine the availability of the RNM computer system 190. The RNM availability logic 132 may determine the availability based on a business calendar of the RNM computer system 190. For instance, the RNM availability logic 132 may retrieve calendar information for the RNM computer system 190 from the data storage system 160. The RNM availability logic 132 may also retrieve calendar information from calendar 192 on the RNM computer system 190, such as upon request. The RNM availability logic 132 may determine the availability of the RNM computer system 190 based on a relevant time, such as upon completion of the aggregator processing time.

The RNM processing time logic 134 may, when executed, determine (e.g., estimate, calculate) a processing time required to make the remittance funds available to the recipient once the payment instruction is received from the aggregator computer system 180 (i.e., the RNM processing time). The RNM processing time may be determined by the RNM processing time logic 134 based on information stored in the data storage system 160, including information related to previous similar remittance payments. For instance, the RNM processing time logic 134 may estimate the RNM processing time based on processed remittance payments that utilized a similar RNM, a similar receiving method, and/or a similar payment type. Again, the RNM processing time logic 134 may determine the RNM processing time according to a “worst case” scenario in order to ensure that the remittance payment is available to the intended recipient at the time of the availability date.

The provider bank computer system 110 also includes a dynamic transaction disclosure receipt (DTDR) generator 140. The DTDR may be provided to the payor 105 upon receiving a request from the payor 105 to process a remittance payment. The DTDR includes information related to the requested remittance payment, including any information that may be relevant to the payor 105 prior to confirming submission of the remittance payment request. For instance, the availability date calculator 120 may provide the availability date to the DTDR generator 140 for inclusion on the DTDR. The DTDR generator 140 includes foreign tax determination logic 142, customer message logic 144, fee savings determination logic 146, and language implementation logic 148. Such logic may be implemented in a machine (e.g., one or more networked computer servers) comprising machine-readable media having instructions stored therein which are executed by the machine to perform the operations described herein. For instance, such logic may be implemented and executed to derive values for disclosure to the payor 105 as part of the DTDR.

The foreign tax determination logic 142 may, when executed, determine the foreign taxes and fees that will apply to the remittance payment requested by the payor 105. The DTDR generator 140 may include the foreign taxes and fees determined by the foreign tax determination logic 142 as part of the DTDR that is presented to the payor 105. The total amount of foreign taxes and fees that are required to complete the remittance payment are presented to the payor 105 within a designated field of the DTDR such that the payor 105 is aware of the associated taxes and fees prior to confirming the payment. The foreign taxes and fees may be displayed as a flat amount or as a percentage of the remittance payment.

The foreign tax determination logic 142 may determine the foreign taxes and fees based on the information provided by the payor 105 and based on other information available within the system 100. For instance, the foreign taxes and fees may be partially based on the payor 105 location and the recipient location, which may be provided by the payor 105 at the time the payor 105 requests the remittance payment. The foreign taxes and fees may also be based on the payment type, which may be selected or otherwise provided by the payor 105. The foreign taxes and fees may also be based on how the payment will be routed, including the specific messaging computer system 175, aggregator computer system 180, and/or RNM computer system 190 that is utilized to process the remittance payment. The foreign tax determination logic 142 may retrieve information from any of the systems 160, 175, 180, and 190 in order to determine any foreign taxes or fees that are associated with a particular payment route associated with the remittance payment. For instance, the provider bank computer system 110 (e.g., payment processing logic 154) may determine how the payment will be routed based on the information provided by the payor 105 and the foreign tax determination logic 142 may determine the associated foreign taxes and fees based on how the payment will be routed.

The customer message logic 144 may, when executed, provide targeted messages to the payor 105 (i.e., the customer). The customer message logic 144 may determine which messages to provide to the payor 105 based on details of the particular transaction (i.e., the remittance payment), including an associated location (e.g., province, country, city, etc.) of the payor 105 or the recipient, the RNM processing the payment, the aggregator, and the method of payment (e.g., receiving method). In an example embodiment, the customer message logic 144 “flags,” or selects, various automated messages to display to the payor 105 based on the particular details of the transaction, such as processing delays and additional fees. The customer message logic 144 may also generate targeted messages based on the transaction, including messages that are targeted to the payor 105 and/or the recipient. The customer message logic 144 may cause the messages to be displayed to the payor 105 within a designated field of the DTDR. The customer message logic 144 may be configured to only provide messages via the DTDR when the designated message and/or the remittance payment are active.

As an example of a message that may be provided by the customer message logic 144, the recipient of a remittance payment may be located in a province having a local holiday or experiencing some other local event that may affect the transaction. In this case, the customer message logic 144 may identify the event based on the recipient location and generate a message to the payor 105 informing the payor 105 that a delay may occur due to the local event. The customer message logic 144 may also determine when local emergencies are present, when a particular tax may apply to the payment based on a location or payment type, or any other information relevant to the transaction. The messages generated by the customer message logic 144 may be saved along with a record of the remittance payment and stored within the data storage system 160.

The fee savings determination logic 146 may, when executed, determine any discounts or offers that may be available to the payor 105 as part of the remittance payment. The discounts or offers provided may include discounts on standard fees based on a particular relationship with the payor 105. For instance, certain discounts may be provided to new customers or special members or customers (i.e., loyalty members, platinum card holders, etc.) of the provider bank. The fee savings determination logic 146 may also seek out discounts or offers that may be available based on the details of the transaction. For instance, the provider bank computer system 110 may waive all fees for remittance payments to recipients within an area that has been affected by a natural disaster or other local emergency in order to provide an easier method for sending funds to the area. The fee savings determination logic 146 may determine that the discount is available and disclose the discount to the payor 105 with the DTDR.

The fee savings determination logic 146 may also cause the promotional information, including any discounts or offers, to be displayed to the payor 105 in a field of the DTDR prior to receiving confirmation of the remittance payment request from the payor 105. The promotional information may include a promotional amount, such as a savings or reduced cost, as well as the reason for the promotion. In an example embodiment, the DTDR includes a “You Saved” field in which a total savings amount may be disclosed to the payor 105. The fee savings determination logic 146 may determine the total savings provided to the payor 105 by calculating the standard fees, calculating the actual fees, and determining the difference between the two. The fee savings determination logic 146 may populate the “You Saved” field with a total savings amount and a reason for the savings.

The language implementation logic 148 may, when executed, determine a secondary language (other than English) associated with the remittance payment. For instance, the payor 105 may have requested the remittance payment using a language other than English, such as by phone, by ATM, through an online banking site, or with an in-person teller. The language implementation logic 148 may retrieve the secondary language information associated with the remittance payment request and apply the secondary language throughout the transaction, including to provide the DTDR in both the secondary language and English. The language implementation logic 148 may also determine a secondary language in which the transaction was advertised, a secondary language the payor 105 uses to provide identification via automated teller, or a secondary language the payor 105 has used in phone conversations with the provider bank regarding the transaction. The language implementation logic 148 may then assign the secondary language to other communications that are provided to the payor 105 throughout the transaction, such that any communication is available in both the secondary language and English.

In an automated teller platform, the payor 105 may be required to key in a language when requesting a remittance payment. The language implementation logic 148 may determine when a secondary language is selected and produce a bilingual DTDR. The language implementation logic 148 may also cause the automated teller platform to display further messages in both English and the secondary language, including messages to determine whether the payor 105 has received the DTDR and agreed to its terms (i.e., confirmed the remittance payment request). A receipt may also be provided to the payor 105 after the remittance payment is completed as proof of payment. The language implementation logic 148 may cause the proof of payment receipt to be provided in both the secondary language and English.

The language implementation logic 148 may also cause any other follow-up materials sent to the payor 105 to be provided in both the secondary language and English. For instance, a mail receipt may be provided to the payor 105 after a remittance payment is requested by phone. The language implementation logic 148 may cause the mail receipt and an associated cover letter to be provided, along with the DTDR, in both the secondary language and English. Further, any follow-up materials that are provided in response to a dispute with the payor 105 (e.g., reported by phone) may be provided in both the secondary language and English, such as if the dispute was reported in the secondary language.

The DTDR generator 140 may be configured to generate a DTDR upon receipt of a remittance payment request. For instance, the provider bank computer system 110 may be required to provide a DTDR or other disclosure information to the payor 105 before proceeding with the transaction. The payor 105 may be required to approve or confirm the information within the DTDR prior to completing the transaction. In addition to generating the DTDR upon receiving a request to process a remittance payment, the DTDR generator 140 may also be used to re-constitute a DTDR. For instance, the values derived by the DTDR generator 140 and the availability date calculator 120 may be stored in data storage system 160 for use in re-creating a DTDR from a past transaction. The DTDR generator 140 may include various templates for a DTDR based on a type of transaction. The DTDR generator 140 may populate a stored template with stored values that were previously derived in order to reproduce or re-create a previously generated DTDR. For instance, a DTDR may be reproduced for a customer's records or to provide proof that a DTDR was generated.

The provider bank computer system 110 also includes a payment cancellation system 150. The payment cancellation system 150 is configured to receive cancellation of the remittance payment from the payor 105 and provide a full refund of the payment to the payor 105, including transaction fees. In an example embodiment, the provider bank computer system 110 provides a designated cancellation period for the payor 105 to cancel the remittance payment and recoup the entirety of the payment, including fees. The cancellation period may begin after the payor 105 receives the disclosure information (i.e., the DTDR) and confirms the details of the payment. In one embodiment, the payor 105 is allotted a cancellation period of 30 minutes upon confirming the payment to cancel and receive a full refund.

The payment cancellation system 150 is configured to receive a notice of cancellation from the payor 105 by more than one channel of communication. As a result, the payor 105 is not required to provide notice of cancellation via the same communication channel that was used to request the payment. For instance, the payor 105 may request and confirm a remittance payment by phone, then cancel the payment within the cancellation period via an online banking area provided by the provider bank. The payment cancellation system 150 is configured to receive notice of the cancellation via the online banking area and cancel the requested payment. The payment cancellation system 150 may then send a communication to the payor 105 via one or more of the communication channels to notify the payor 105 that the payment has been canceled.

The provider bank computer system 110 also includes a remedy processing system 152. The remedy processing system 152 is configured to provide a remedy for the payor 105 for a transaction in which an error has occurred through no fault of the payor 105. For instance, if the payor 105 identifies an error with a particular transaction, the payor 105 may provide notice to the provider bank computer system 110 via the remedy processing system 152. The remedy processing system 152 may review the transaction, including the error, and determine the proper remedy to be provided to the payor 105. If the proper remedy is a cash amount, such as a refund of improperly charged fees or taxes, the remedy processing system 152 may allow the payor 105 to choose how the remedy is paid out. In an example embodiment, the payor 105 may be able to select whether to refund the amount of the remedy to the payor 105 or to send the amount of the remedy to the recipient. The remedy processing system 152 may be configured to receive the selection as a message from the payor 105. The remedy processing system 152 may then send the remedy amount, or portions of the remedy amount, to the selected persons based on the preferences of the payor 105. The remedy processing system 152 may also include default remedy preferences for paying a remedy amount in absence of a selection by the payor 105. For instance, the remedy processing system 152 may be configured to automatically refund the remedy amount to the payor 105 if a selection is not received from the payor 105 within a predetermined period of time. The remedy processing system 152 may also provide a recommendation to the payor 105 for payment of the remedy, and the default remedy payment may be according to the provided recommendation.

The provider bank computer system 110 also includes payment processing logic 154. The payment processing logic 154 may, when executed, determine how the remittance payment will be processed. For instance, the payment processing logic 154 may determine which payment type is most efficient, which of the aggregators to utilize, which of the RNMs to utilize, whether to send a payment instruction via the messaging computer system 175, or make any other determinations described within in relation to the remittance payment.

The provider bank computer system 110 also includes the data storage system 160. The data storage system 160 may include information related to past transactions, the payor 105, customers of the provider bank, the provider bank computer system 110, the messaging computer system 175, the aggregator computer system 180, and the RNM computer system 190. The data storage system 160 may also include values derived by logic stored within the availability date calculator 120, the DTDR generator 140, or any other components of the system 100. The availability date calculator 120, the DTDR generator 140, the payment cancellation system 150, the remedy processing system 152, and the payment processing logic 154 may also be configured to retrieve data stored within the data storage system 160 as part of the operations described herein.

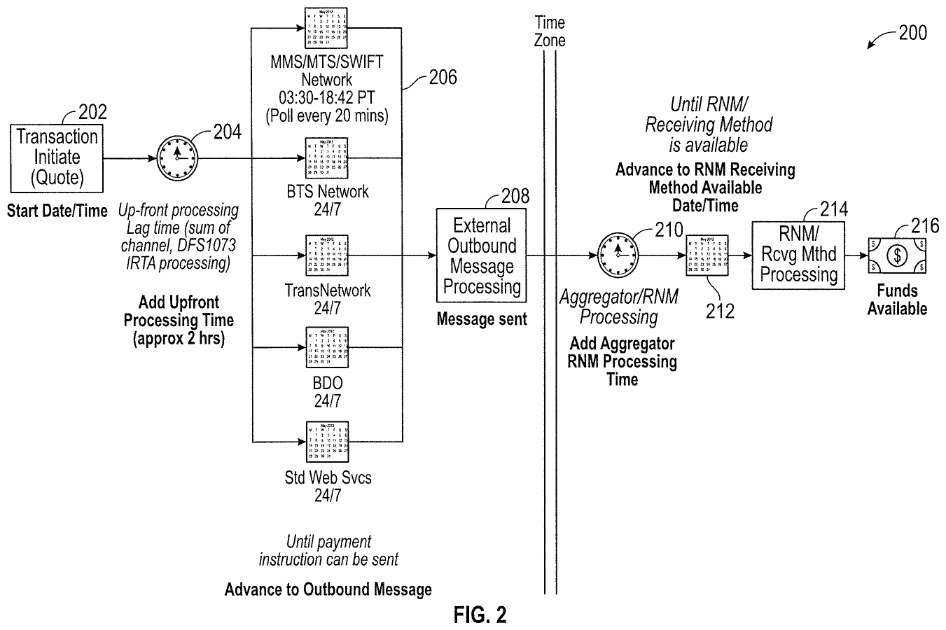

Referring now to FIG. 2, a process 200 is shown for determining an availability date for a remittance payment. The process 200 may be performed using the provider bank computer system 110 shown in FIG. 1. More specifically, the process 200 may be performed using the availability date calculator 120 of the provider bank computer system 110. For instance, the payor 105 may request a remittance payment to be sent to a recipient using the provider bank computer system 110. The request may be received by the provider bank computer system 110. The payor 105 may provide information related to the remittance payment to the provider bank computer system 110, including the recipient, a recipient location, a payment amount, a payment type, and other details intended to identify the specific type of payment that is requested. The provider bank computer system 110 may be required to provide disclosure information to the payor 105 that is related to the payment, including a date by which the payment will be available to the recipient (i.e., an availability date). Upon approval or confirmation of the disclosure details by the payor 105, including the availability date, the provider bank computer system 110 may transmit the payment request for processing.

At 202, the start date is determined. The start date may be based on the current date at the time a remittance payment is requested. The start date provides a starting point for determining the availability date of the payment. The start date includes a calendar date as well as a time of day. In an example embodiment, the start date is determined according to the time zone of the payor 105, but in other embodiments the start date may be determined according to a time zone of the recipient or the provider bank computer system 110.

At 204, the processing lag time is determined and added to the start date. The processing lag time may refer to a duration in minutes which allows for the time between when the estimated availability date is calculated and presented to the payor 105, and when the payment instruction is ready to be transmitted by the provider bank computer system 110. The processing lag time may include, for instance, a channel lag time, which is a duration of time between when the availability date is provided to the payor 105 and when the payor 105 confirms the payment. The channel lag time may be a predetermined amount of time or may be based on a processing speed of the provider bank computer system 110.

The processing lag time may also include a cancellation period, which is a duration of time during which the provider bank computer system 110 may freeze the payment to allow the payor 105 to cancel the transaction without penalty. In an example embodiment, the cancellation period is approximately thirty (30) minutes, such that, after confirming the payment, the payor 105 has thirty minutes to cancel the payment request and receive a full refund. The processing lag time may also include any system processing time associated with the provider bank computer system 110, including the availability date calculator 120. At 204, each of the lag times is determined and summed to produce a total processing lag time. In an example embodiment, the availability date calculator 120 is configured to determine the longest possible duration, or a “worst case” scenario, for the processing lag time in order to ensure that the payment funds are available to the recipient by the estimated availability date. Once the processing lag time is determined (e.g., estimated), the processing lag time is then added to the start date. For instance, if the initial start date was Oct. 21, 2015 at 10:00 AM and the total processing lag time was 41 minutes, the estimated availability date at step 204 would be Oct. 21, 2015 at 10:41 AM.

At 206, the availability of an aggregator (e.g., aggregator computer system 180) or other partner is determined based on the estimated availability date from step 204. For instance, the availability date calculator 120 may retrieve a business calendar for the aggregator computer system 180 from the data storage system 160 or directly from the aggregator computer system 180. Based on the business calendar, if the current estimated availability date is not a business day for the aggregator computer system 180, then the current estimated availability date is moved to the next business day. If the current estimated availability date is within a business day for the aggregator computer system 180, then the processing calendar for the aggregator computer system 180 is consulted. The processing calendar may be included as part of the business calendar or may be separately retrieved (e.g., from the data storage system 160, from system 180) by the availability date calculator 120. If the current estimated availability date is not within the scheduled processing time of the aggregator computer system 180, then the estimated availability date is moved to the first scheduled processing time of the aggregator computer system 180. If the current estimated availability date is within the scheduled processing time, then the estimated availability date is held.

At 208, the availability of an external messaging system (e.g., messaging computer system 175) may be determined based on the current estimated availability date. For instance, if an external messaging system is utilized to send a payment instruction from the provider bank computer system 110 to the aggregator computer system 180, then availability of the messaging computer system 175 is determined. In such a case, if the messaging computer system 175 is not available based on the current estimated availability date, then the estimated availability date is moved to the next business day of the messaging computer system 175.

At 210, the aggregator processing lag time is determined and added to the estimated availability date. The aggregator processing lag time includes a duration which allows for any processing time by the aggregator computer system 180. The aggregator processing lag time may include time after receipt of the payment instruction by the aggregator computer system 180 before it can be available in a form of the given RNM (e.g., RNM computer system 190). The duration of the aggregator processing lag time may vary according to payment method, receiving method by the RNM computer system 190, and based on other conditions related to the remittance payment. In an example embodiment, the availability date calculator 120 is configured to determine the longest possible duration, or a “worst case” scenario, for the aggregator processing lag time in order to ensure that the payment funds are available to the recipient by the estimated availability date. Once the aggregator processing lag time is determined (e.g., estimated), the aggregator processing lag time is added to the current estimated availability date in a manner similar to the processing lag time above at 204.

At 212, the availability of an RNM (e.g., RNM computer system 190) or other receiving endpoint is determined based on the estimated availability date from step 210. For instance, the availability date calculator 120 may retrieve a business calendar for the RNM computer system 190 from the data storage system 160 or directly from the RNM computer system 190. Based on the business calendar, if the current estimated availability date is not a business day for the RNM computer system 190, then the current estimated availability date is moved to the next business day. If the current estimated availability date falls on a business day for the RNM computer system 190, then the processing calendar for the RNM computer system 190 is consulted. The processing calendar may be included as part of the business calendar or may be separately retrieved (e.g., from the data storage system 160, from system 190) by the availability date calculator 120. If the current estimated availability date is not within the scheduled processing time of the RNM computer system 190, then the estimated availability date is moved to the first scheduled processing time of the RNM computer system 190. If the current estimated availability date is within the scheduled processing time, then the estimated availability date is held.

At 214, the processing time at the RNM computer system 190 is determined and added to the estimated availability date. The processing time at the RNM computer system 190 may be negligible, such that the funds are available to the recipient as soon as they are received. At 216, the estimated availability date is determined and may be provided to the payor 105 as part of the remittance payment disclosure materials.

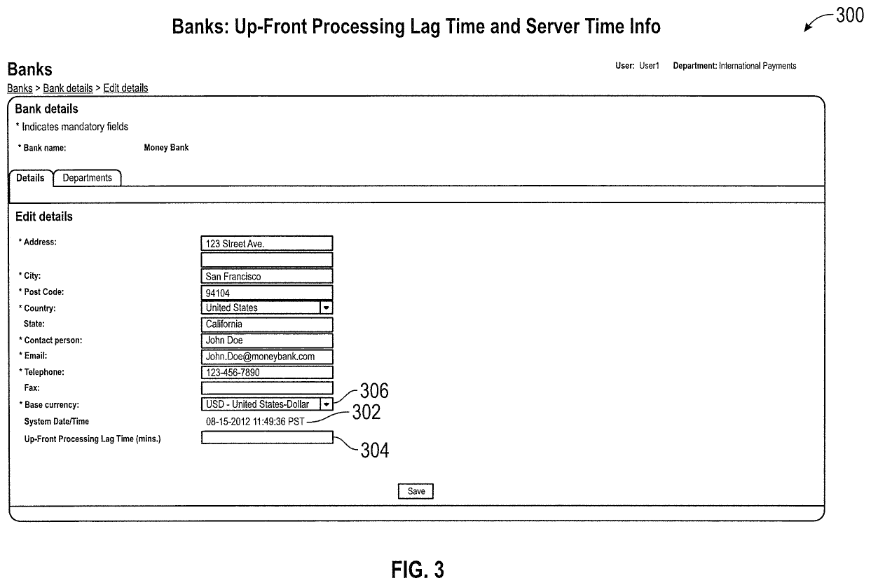

Referring now to FIGS. 3-9, screen displays for various user interfaces are shown to include information related to the remittance payment processing system 100. The screen displays may be provided by the provider bank computer system 110 and in accordance with the remittance payment processing system 100. The information provided via the user interfaces may be used to calculate an availability date by which a remittance payment is made available to a recipient, such as using process 200. Some of the information may also be required to be disclosed to the payor 105 prior to the payor 105 accepting or confirming the remittance payment. The user interfaces shown in FIGS. 3-9 may be made available to an agent at the provider bank computer system 110, the messaging computer system 175, the aggregator computer system 180, the RNM computer system 190, or to the payor 105 via any of the systems described herein.

Referring to FIG. 3, screen 300 shows a user interface for the provider bank computer system 110, according to an example embodiment. Screen 300 displays information related to the provider bank computer system 110, which may include identifying information related to the associated provider bank. Screen 300 includes various fields for the user (e.g., the payor 105, an agent of the provider bank, etc.) to enter information related to the provider bank, including a location of the provider bank, a contact person, and contact information. Screen 300 includes a system date/time field 302, which reflects the current date, time, and time zone of the application server. The system date/time field 302 may be read-only and automatically populated by the provider bank computer system 110 based on an internal clock. The system date/time field 302 may be used as the start date (i.e., start time) in order to calculate the availability date of the remittance payment. Screen 300 also includes a processing lag time field 304. The processing lag time field 304 may include a processing lag time for the provider bank computer system 110, which may be used by the availability date calculator 120 to determine the processing lag time and calculate the availability date for the remittance payment. The processing lag time field 304 may also be read-only and populated by the provider bank computer system 110 based on one or more parameters associated with the provider bank computer system 110. The processing lag time may be provided (in field 304) as an integer (e.g., in minutes or seconds). The user interface 300 also includes a base currency field 306 for indicating the base currency (e.g., U.S. dollars) of the particular remittance payment or the base currency typically used by the provider bank.

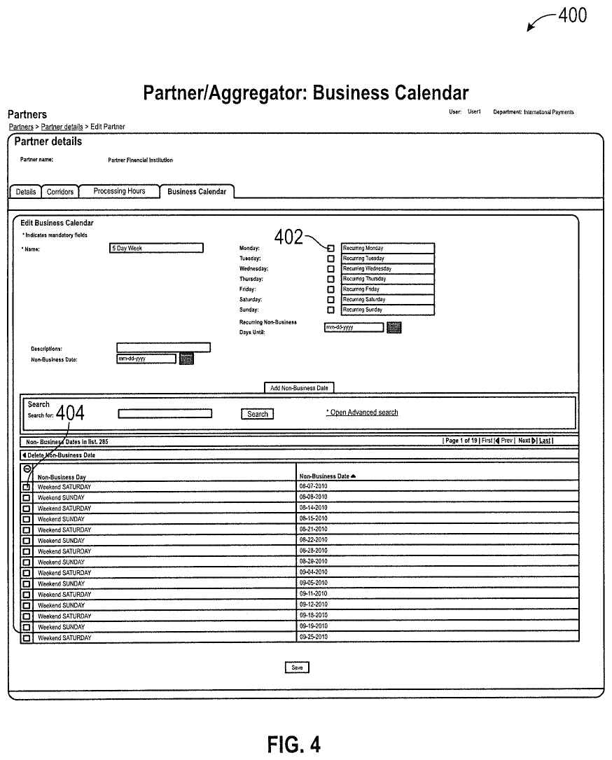

Referring to FIG. 4, screen 400 shows a user interface displaying a business calendar for the aggregator computer system 180. The business calendar may be used by the aggregator availability logic 128 to determine availability of the aggregator computer system 180 for the purposes of calculating the availability date for the remittance payment. In the illustrated embodiment, the business calendar may be edited. Thus, the screen 400 may be provided to an agent of the aggregator computer system 180 or the provider bank computer system 110 in order to update the business calendar of the aggregator and provide more accurate information for use in calculating the availability date of the remittance payment. In the example embodiment, for instance, the user interface 400 includes selectable boxes 402 for indicating future non-business days for the aggregator that may be recurring. Likewise, boxes 404 are provided for indicating one-time future non-business days for the aggregator. The indicated non-business days may be used to calculate the availability date as described herein. In other embodiments, the business calendar shown in screen 400 may not be editable. For instance, the business calendar may simply be provided as read-only for use in determining the availability date, such as via the availability date calculator 120.

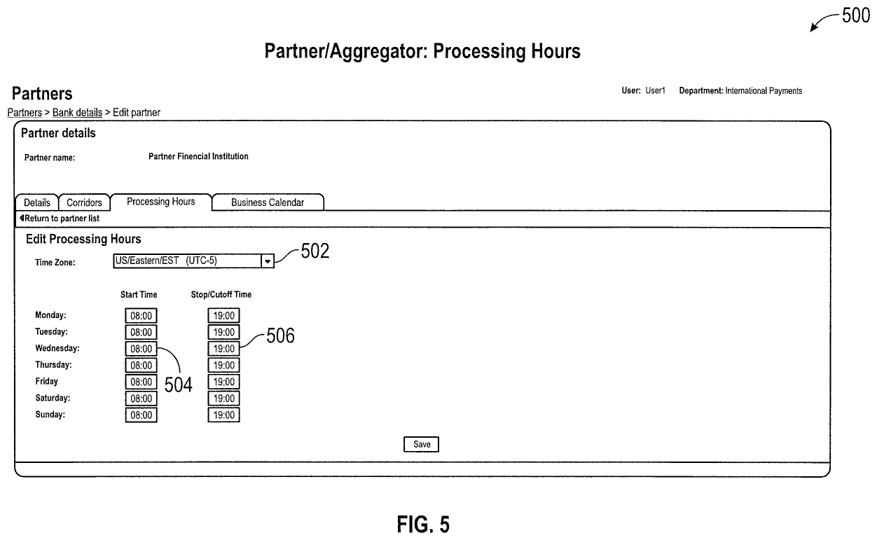

Referring to FIG. 5, screen 500 shows a user interface displaying processing hours for the aggregator computer system 180. The processing hours may be also be used by the aggregator availability logic 128 to determine availability of the aggregator computer system 180 and calculate the availability date for the remittance payment. In particular, the processing hours may be used to determine when the aggregator computer system 180 is available to process a payment instruction received from the provider bank computer system 110. The processing hours may be editable in some embodiments, and in other embodiments may be provided as read-only, depending on the particular transaction and the accessing party. In the example embodiment, the user interface 500 includes time zone field 502 for selecting a time zone of the aggregator or other entity associated with the system 100. The user interface 500 is also shown to include start time fields 504 and end time fields 506 for indicating when the aggregator is available (i.e., the processing hours) for each day of the week.

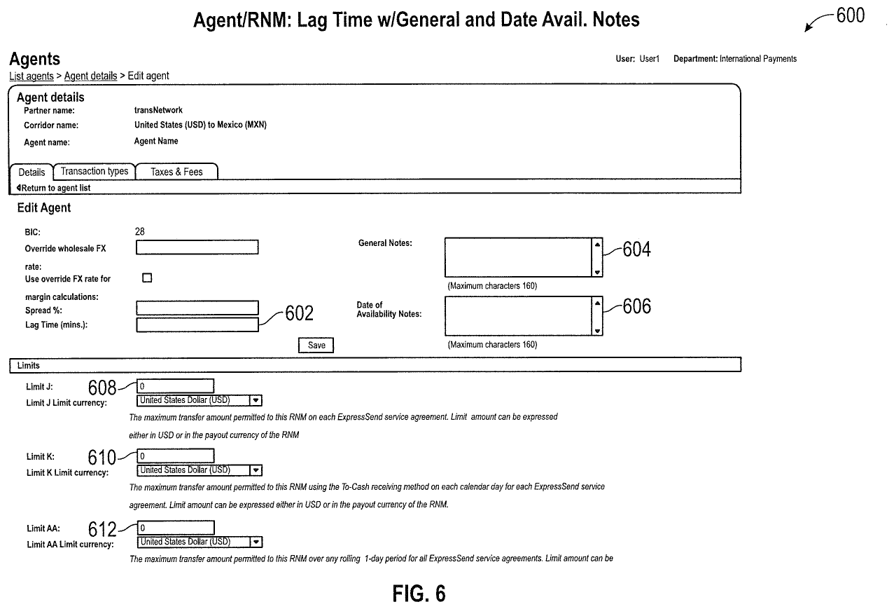

Referring to FIG. 6, screen 600 shows a user interface displaying information related to the RNM computer system 190. The screen 600 includes a lag time field 602, which may reflect a current processing lag time (e.g., in minutes) for the RNM computer system 190. The current processing lag time may be an average lag time or a maximum lag time over a set period of time. The current processing lag time may be read-only for the user and provided (e.g., by system 190) in field 602 according to any of the processes described herein. The current processing lag time may also be otherwise received or determined and entered manually by a user of the system 110 in field 602. The screen 600 also includes field 604 for general notes related to the lag time or otherwise related to the remittance payment and field 606 for other notes related to the date of availability. The notes entered in fields 604 and 606 may be provided to the payor 105 along with the date of availability. Fields 608-612 include various limits associated with the remittance payment. In the example embodiment, field 608 indicates the maximum transfer amount permitted to the RNM on each “ExpressSend” service agreement, which may be a maximum transfer amount per a particular service agreement between the any of the entities of system 100. In this embodiment, the field 610 indicates a maximum transfer amount permitted to the RNM using a particular receiving method on each calendar day for each service agreement. The field 612 indicates a maximum transfer amount permitted to the RNM over any rolling 1-day period for all service agreements. The fields 608-612 may be populated by the user. In other embodiments, similar fields may be provided in order to set various limits related to remittance payments and any of the entities of system 100 or parties otherwise associated with a particular remittance payment.

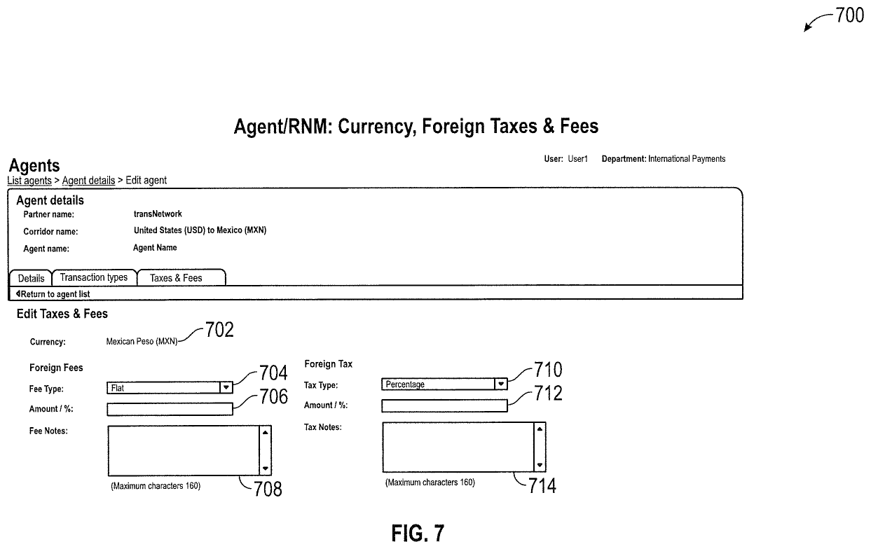

Referring to FIG. 7, screen 700 shows a user interface displaying information related to the foreign taxes and fees assigned to a particular remittance payment. The foreign taxes and fees may be based on the RNM computer system 190, including the location of the RNM computer system 190. The screen 700 includes various fields for showing a percentage tax or total tax amount, as well as fields for notes explaining why the taxes or fees were applied. In the example embodiment, field 702 displays the type of currency for the remittance payment and/or the calculated fees or taxes. In this embodiment, the field 702 is read-only but the field may also be edited by the user. Field 704 indicates the type of fee applied to the remittance payment (i.e., flat fee, percentage amount). Field 706 indicates the fee amount, which may be a percentage amount or a flat fee amount. Field 708 provides any notes associated with a foreign fee. Fields 710-714 are similar to fields 704-708 but are applicable to a foreign tax rather than a foreign fee. Any of the fields 704-714 may be edited by the user in order to calculate the amount of taxes and fees associated with a particular remittance payment.

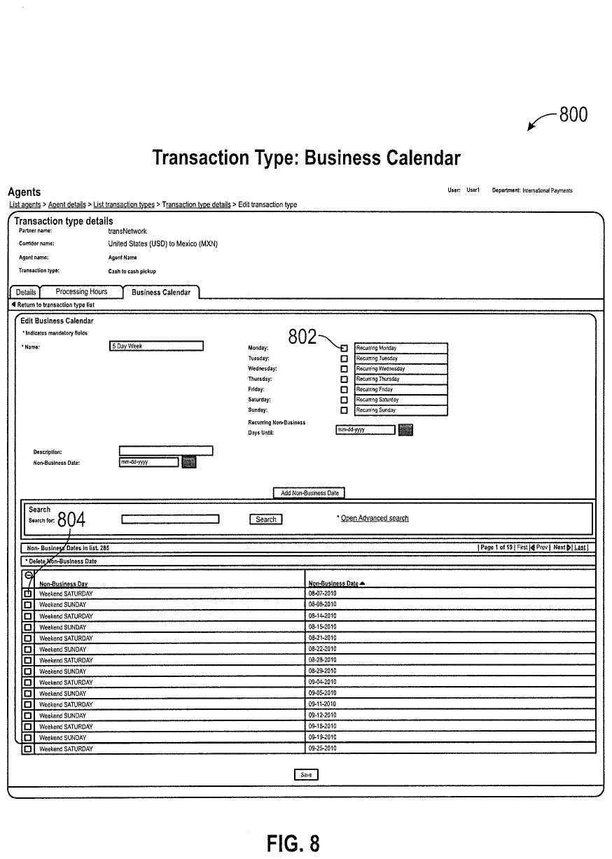

Referring to FIG. 8, screen 800 shows a user interface displaying information related to the business calendar (i.e., business calendar 192) of the RNM computer system 190. The information displayed by screen 800 is similar to the business calendar information of screen 400, but relates to the RNM computer system 190 rather than the aggregator computer system 180. The user interface 800 may be used to indicate any non-business days for the RNM computer system 190. The information provided using the user interface 800 may be used by the RNM availability logic 132 to determine availability of the RNM computer system 190 for the purposes of calculating the availability date of the remittance payment. In the illustrated embodiment, the business calendar 192 may be edited. Thus, the screen 800 may be provided to an agent of the RNM computer system 190 or the provider bank computer system 110 in order to update the business calendar of the RNM and provide more accurate information for use in calculating the availability date of the remittance payment. In the example embodiment, for instance, the user interface 800 includes selectable boxes 802 for indicating future non-business days for the RNM computer system 190 that may be recurring. Likewise, boxes 804 are provided for indicating one-time future non-business days for the RNM computer system 190. The indicated non-business days may be used to calculate the availability date as described herein. In other embodiments, the business calendar information shown in screen 800 may not be editable. For instance, the business calendar 192 may simply be provided as read-only for use in determining the availability date.

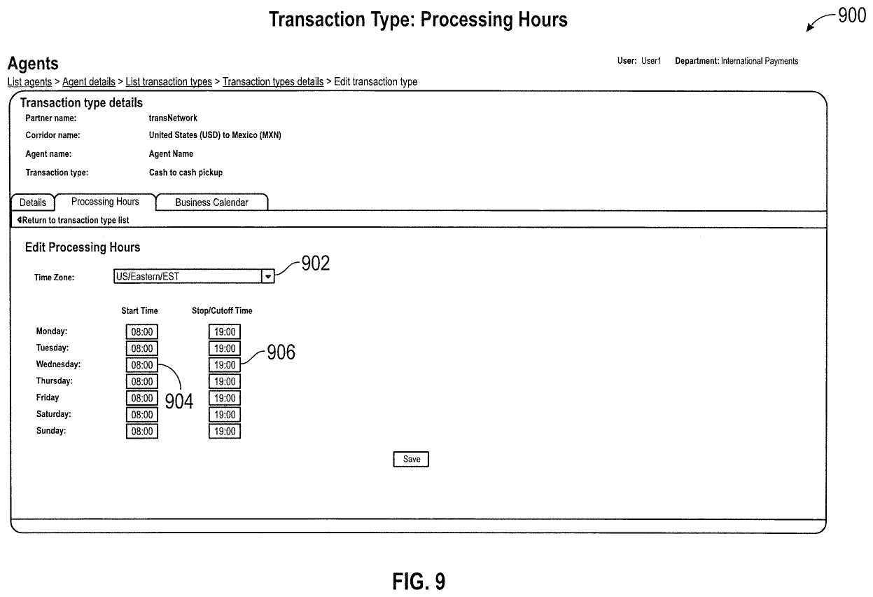

Referring to FIG. 9, screen 900 shows a user interface displaying processing hours for the RNM computer system 190. The processing hours may be also be used by the RNM availability logic 132 to determine availability of the RNM computer system 190 for the purposes of calculating the availability date for the remittance payment. The processing hours may be used to determine when the RNM computer system 190 is available to process a payment instruction received from the provider bank computer system 110. The processing hours may be editable in some embodiments, and in other embodiments may be provided as read-only, depending on the particular transaction and the accessing party. In the example embodiment, the user interface 900 includes time zone field 902 for selecting a time zone of the RNM computer system 190 or other entity associated with the system 100. The user interface 900 is also shown to include start time fields 904 and end time fields 906 for indicating when the RNM computer system 190 is available (i.e., the processing hours) for each day of the week.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions. Software implementations could be accomplished with standard programming techniques with rule based logic and other logic to accomplish the various connection steps, processing steps, comparison steps and decision steps.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

1. A computer-implemented method performed by one or more processors of a remittance provider computer system, the method comprising:
based on a request from a payor to initiate a remittance payment, determining, by the remittance provider computer system, a start time for processing the remittance payment;
responsive to determining the start time, calculating, by the remittance provider computer system, an initial processing duration attributable to the remittance provider computer system and associated with the remittance payment, wherein the initial processing duration is calculated by summing at least:
(i) a time between when a date of availability for a payee to access the remittance payment is provided to the payor, and when a payment instruction for the remittance payment is transmitted to a partner associated with the remittance provider computer system,
(ii) a cancellation period, wherein the cancellation period is a predetermined period of time in which the remittance payment can be canceled without penalty to the payor, and
(iii) the start time for processing the remittance payment;
providing, by the remittance provider computer system to a partner computer system associated with the partner, a user interface displaying a calendar comprising a first selectable object associated with a first date that when actuated indicates that the partner will not process the remittance payment on the first date, and a second selectable object associated with a second date that when actuated indicates that the partner will not process the remittance payment on the second date;
receiving, by the remittance provider computer system via at least the first selectable object and the second selectable object of the calendar, calendar information from the partner that indicates the partner will not process the remittance payment on the first date but is available to process the remittance payment on the second date;
determining, by the remittance provider computer system, availability of the partner to process the remittance payment based on the calendar information received via the first selectable object and the second selectable object, wherein the availability of the partner includes the second date and does not include the first date, and is determined according to the start time and the initial processing duration and based on processing hours indicated in the calendar information received from the partner;
determining, by the remittance provider computer system, a partner processing duration for the partner to process the remittance payment using the second date;
determining, by the remittance provider computer system, the date of availability for the payee to access the remittance payment via a payee account of a payee bank, wherein the date of availability is calculated based on the availability of the partner to process the remittance payment and the partner processing duration;
determining, by the remittance provider computer system, an adjustment to the remittance payment based on account information of the payor and a location of the payee bank corresponding to the payee account;
generating, by the remittance provider computer system, a disclosure receipt based on the adjustment to the remittance payment, the disclosure receipt comprising one or more terms of the remittance payment, an indication of the adjustment to the remittance payment, and the date of availability; and
providing, by the remittance provider computer system, the disclosure receipt to the payor, the disclosure receipt including the one or more terms of the remittance payment, the indication of the adjustment to the remittance payment, and the date of availability.

2. The computer-implemented method of claim 1, wherein the disclosure receipt is provided to the payor prior to processing the remittance payment.

3. (canceled)

4. The computer-implemented method of claim 1, further comprising:
determining, by the remittance provider computer system, availability of a remittance network member (RNM) computer system to receive the remittance payment, wherein the availability of the RNM computer system is determined according to the availability of the partner and the partner processing duration, and based on calendar information received from the RNM computer system; and
calculating, by the remittance provider computer system, an RNM processing duration for the RNM computer system to process the remittance payment such that funds related to the remittance payment are available to the payee, wherein the date of availability is calculated based on the availability of the RNM computer system and the RNM processing duration.

5. The computer-implemented method of claim 1, further comprising prior to determining the availability of the partner, calculating, by the remittance provider computer system, a modified start time by adding the initial processing duration to the start time, wherein the availability of the partner is determined according to the modified start time.

6. The computer-implemented method of claim 5, wherein determining the availability of the partner comprises:
determining a next available business day for the partner based on the calendar information and such that the next available business day is at or after the modified start time; and
determining a next available processing time for the partner to process the remittance payment, wherein the next available processing time is determined based on the calendar information and such that the next available processing time is on or after the next available business day.

7. The computer-implemented method of claim 6, wherein the next available processing time is determined such that an associated processing window starting at the next available processing time is greater than or equal to the partner processing duration.

8. The computer-implemented method of claim 6, wherein the date of availability is determined by adding the partner processing duration to the next available processing time.

9. A computer-implemented method performed by one or more processors of a remittance provider computer system, the method comprising:
receiving, at the remittance provider computer system, a request from a payor to initiate a remittance payment;
calculating, by the remittance provider computer system, a date of availability for a payee to access funds related to the remittance payment, including:
based on the request, determining a start time for processing the remittance payment;
calculating an initial processing duration attributable to the remittance provider computer system and associated with the remittance payment, wherein the initial processing duration is calculated by summing at least:
(i) a time between when the date of availability is provided to the payor and when a payment instruction for the remittance payment is sent to an aggregator computer system,
(ii) a cancellation period, wherein the cancellation period is a predetermined period of time in which the remittance payment can be canceled without penalty to the payor, and
(iii) the start time for processing the remittance payment;
providing, by the remittance provider computer system to the aggregator computer system, a user interface displaying a calendar comprising a first selectable object associated with a first date that when actuated indicates that the aggregator computer system will not process the remittance payment on the first date, and a second selectable object associated with a second date that when actuated indicates that the aggregator computer system will not process the remittance payment on the second date;
receiving, by the remittance provider computer system via at least the first selectable object and the second selectable object of the calendar, calendar information from the aggregator computer system that indicates the aggregator computer system will not process the remittance payment on the first date but is available to process the remittance payment on the second date;
determining, by the remittance provider computer system, availability of the aggregator computer system to process the remittance payment based on the calendar information received via the first selectable object and the second selectable object, wherein the availability of the aggregator computer system includes the second date and does not include the first date, and is determined according to the start time and the initial processing duration, and based on processing hours indicated in the calendar information received from the aggregator computer system; and
calculating, by the remittance provider computer system, an aggregator processing duration for the aggregator computer system to process the remittance payment, wherein the date of availability is calculated based on the availability of the aggregator computer system and the aggregator processing duration;
determining, by the remittance provider computer system, an adjustment to the remittance payment based on account information of the payor and a location of a payee bank corresponding to a payee account of the payee bank;
generating, by the remittance provider computer system, a disclosure receipt based on the adjustment to the remittance payment, the disclosure receipt comprising one or more terms of the remittance payment, an indication of the adjustment to the remittance payment, and the date of availability; and
providing, by the remittance provider computer system, the disclosure receipt to the payor prior to processing the remittance payment, the disclosure receipt including the one or more terms of the remittance payment, the one or more terms including the date of availability.

10. The computer-implemented method of claim 9, wherein calculating the date of availability further comprises:
determining availability of a remittance network member (RNM) computer system to process the remittance payment, wherein the availability of the RNM computer system is determined according to the availability of the aggregator computer system and the aggregator processing duration, and based on calendar information received from the RNM computer system; and
determining an RNM processing duration for the RNM computer system to process the remittance payment such that the funds are accessible by the payee, wherein the date of availability is determined based on the availability of the RNM computer system and the RNM processing duration.

11. The computer-implemented method of claim 9, further comprising prior to processing the remittance payment, receiving, at the remittance provider computer system, an indication of acceptance of the one or more terms from the payor.

12. (canceled)

13. The computer-implemented method of claim 9, further comprising prior to determining the availability of the aggregator computer system, calculating, by the remittance provider computer system, a modified start time by adding the initial processing duration to the start time, wherein the availability of the aggregator computer system is determined according to the modified start time.

14. The computer-implemented method of claim 13, wherein determining the availability of the aggregator computer system comprises:
determining a next available business day for the aggregator computer system based on the calendar information and such that the next available business day is at or after the modified start time; and
determining a next available processing time for the aggregator computer system to process the remittance payment, wherein the next available processing time is determined based on the calendar information and such that the next available processing time is on or after the next available business day.

15. The computer-implemented method of claim 14, wherein the next available processing time is determined such that an associated processing window beginning at the next available processing time is greater than or equal to the aggregator processing duration.

16. The computer-implemented method of claim 14, wherein the date of availability is determined by adding the aggregator processing duration to the next available processing time.

17. A computer-implemented method performed by one or more processors of a remittance provider computer system, the method comprising:
receiving, by the remittance provider computer system, a request from a payor to initiate a remittance payment;
calculating, by the remittance provider computer system, a date of availability for a payee to access funds associated with the remittance payment, including:
based on the request, determining a start time for processing the remittance payment;
calculating an initial processing duration attributable to the remittance provider computer system and associated with the remittance payment, wherein the initial processing duration is calculated by summing at least:
(i) a time between when the date of availability is provided to the payor and when a payment instruction for the remittance payment is sent to an aggregator computer system,
(ii) a cancellation period, wherein the cancellation period is a predetermined period of time in which the remittance payment can be canceled without penalty to the payor, and
(iii) the start time for processing the remittance payment;
calculating a modified start time by adding the initial processing duration to the start time;
providing, by the remittance provider computer system to the aggregator computer system, a user interface displaying a calendar comprising a first selectable object associated with a first date that when actuated indicates that the aggregator computer system will not process the remittance payment on the first date, and a second selectable object associated with a second date that when actuated indicates that the aggregator computer system will not process the remittance payment on the second date;
receiving, by the remittance provider computer system via at least the first selectable object and the second selectable object of the calendar, calendar information from the aggregator computer system that indicates the aggregator computer system will not process the remittance payment on the first date but is available to process the remittance payment on the second date;
determining, by the remittance provider computer system, a next available time for the aggregator computer system to process the remittance payment based on the modified start time and the calendar information including the second date and not including the first date received from the aggregator computer system via the first selectable object and the second selectable object;
calculating, by the remittance provider computer system, an aggregator processing duration for the aggregator computer system to process the remittance payment;
generating, by the remittance provider computer system, an aggregator completion time by adding the aggregator processing duration to the next available time of the aggregator computer system;
determining, by the remittance provider computer system, a next available time for a remittance network member (RNM) computer system to process the remittance payment based on the aggregator completion time and calendar information received from the RNM computer system; and
calculating, by the remittance provider computer system, an RNM processing duration for the RNM computer system to process the remittance payment, wherein the date of availability is calculated by adding the RNM processing duration to the aggregator completion time;
determining, by the remittance provider computer system, an adjustment to the remittance payment based on account information of the payor and a location of a payee bank corresponding to a payee account of the payee bank;
generating, by the remittance provider computer system, a disclosure receipt based on the adjustment to the remittance payment, the disclosure receipt comprising one or more terms of the remittance payment, an indication of the adjustment to the remittance payment, and the date of availability; and
providing, by the remittance provider computer system, the disclosure receipt to the payor prior to processing the remittance payment, the disclosure receipt including the one or more terms of the remittance payment, the one or more terms including the date of availability.

18. The computer-implemented method of claim 17, wherein determining the next available time for the aggregator computer system comprises:
determining a next available business day for the aggregator computer system based on the calendar information received from the aggregator computer system and such that the next available business day is at or after the modified start time; and
determining a next available processing time for the aggregator computer system to process the remittance payment, wherein the next available processing time is determined based on the calendar information received from the aggregator computer system and such that the next available processing time is on or after the next available business day.

19. The computer-implemented method of claim 17, further comprising prior to processing the remittance payment, receiving, at the remittance provider computer system, an indication of acceptance of the one or more terms from the payor.

20. (canceled)

21. The computer-implemented method of claim 17, wherein the aggregator processing duration is calculated based on a time between when the payment instruction is received by the aggregator computer system and when the payment instruction is sent to the RNM computer system.
